(19) United States
(12) Patent Application Publication
(10) Pub. No.: US 2007/0182410 A1
(43) Pub. Date: Aug. 9, 2007

(54) Coil sensitivity estimation for parallel imaging

(76) Inventors: Anne Kristiina Niemi, Helsinki (FI); Jukka Iimari Tanttu, Espoo (FI); Mika Petri Ylihautala, Vantaa (FI)

Correspondence Address: PHILIPS INTELLECTUAL PROPERTY & STANDARDS, 595 MINER ROAD, CLEVELAND, OH, 44143, US

(21) Appl. No.: 10/597,129

(22) PCT Filed: Jan. 6, 2005
(86) PCT No.: PCT/IB05/50072

§ 371 Date: Jul. 12, 2006

Related U.S. Application Data
(60) Provisional application No. 60/536,757, filed on Jan. 15, 2004.

(51) Int. Cl. G01V 3/00

(52) U.S. Cl. 324/307; 324/309; 324/318

(57) ABSTRACT

In a parallel or SENSE imaging technique in an MRI system (40), a calibration scan is conducted to generate a calibration image (86) indicative of sensitivity profiles of parallel imaging coils (76a, . . . , 76n) also in the regions where the magnetic field is distorted. This is accomplished by using a phase refocusing imaging protocol such as a spin echo technique, or by using a gradient echo technique where the echo time is very short. In addition, the phase encode direction of the calibration scan and a diagnostic imaging scan shall be matched. A diagnostic imaging scan is conducted using a diagnostic scan protocol to generate a diagnostic image representation from each parallel imaging coil. A SENSE processor (90) reconstructs a final diagnostic image (92) from the diagnostic image representations and the coil sensitivity profiles.

The following relates to the diagnostic imaging arts. It finds particular application in reducing artifacts in magnetic resonance parallel imaging techniques.

In magnetic resonance imaging apparatus used for medical diagnostics of the human body, the body axis is usually oriented along a horizontal x-axis of a rectangular coordinate system. The body region to be examined is situated between the pole pieces of a magnet, which generates a temporally constant main magnetic field, B₀, extending along a vertical or z-axis. A resonator is provided for transmitting the excitation signals and receiving the resonance signals. When a substance such as human tissue is subjected to the uniform magnetic field, B₀, the individual magnetic moments of the spins in the tissue preferentially align with this polarizing field. If the substance, or tissue, is subjected to an excitation radio frequency field, B₁, which is in the x-y plane and which is near a characteristic Larmor frequency, the net aligned moment, M_{Z}, precesses about the z-axis to produce a net transverse magnetic moment, Mₜ. A resonance signal is emitted by the excited spins after the excitation signal B₁ is terminated. This signal may be received and processed to form an image.

When utilizing these signals to produce images, magnetic field gradients, Gₓ, G_{y} and G_{z}, are employed to provide spatial encoding of the resonance signal along x, y, and z axes, respectively. Typically, the region to be imaged is scanned by a sequence of measurement cycles in which these gradients vary according to the particular localization method being used. The resulting set of received NMR signals are digitized and processed to reconstruct the image using one of many well known reconstruction techniques.

One method of acquiring an NMR data set from which an image can be reconstructed employs a variable amplitude phase encoding magnetic field gradient pulse prior to the acquisition of NMR spin-echo signals to phase encode spatial information in the direction of the gradient. In a two-dimensional implementation (2DFT), for example, spatial information is encoded in one direction by applying a phase encoding gradient pulse, G_{y}, prior to each gradient echo signal which is acquired in the presence of a readout magnetic field gradient Gₓ, in a direction orthogonal to the phase encoding direction. The readout gradient present during the spin-echo acquisition also encodes spatial information in a direction orthogonal to the phase encoding gradient. Rather than generating a series of contiguous 2D slice images, a 3D image can be generated by phase encoding along the desired axis. Each echo produces data along a trajectory or line in k-space. Data sets in k-space are inverse Fourier transformed or otherwise reconstructed into image space. The acquisition of each phase encoded data line requires a finite amount of time, and the more data that are required to obtain an image of the prescribed field of view (FOV) and spatial resolution, the longer the total scan time.

Many technical developments in the field of MR imaging aim to reduce data acquisition time. One such development is known as parallel imaging, in which images are acquired with sub-sampled signal acquisitions resulting in fold-over artifacts. The fold-over may be removed by a sensitivity encoding (SENSE) technique. The folded images reconstructed from each coil are combined using the receive coil sensitivities of multiple receive coils with different sensitivity characteristics to unfold the fold-over artifacts. This technique is described by K. P. Pruessmann, et al., “SENSE: Sensitivity Encoding for Fast MRI”, Magnetic Resonance in Medicine 42, 952-962 (1999). The coil sensitivities are estimated from a calibration image scanned with full field-of-view.

Rapid magnetic field changes, occurring at the edges of the homogeneous main magnetic field, or when magnetic materials are introduced in or near to the imaging volume, result in image distortions both in the calibration and the actual acquisition. These distortions appear as abrupt magnitude and phase variations that depend on the acquisition parameters.

In parallel imaging reconstruction, distortions in the sensitivity calibration may result in a failure of the unfolding procedure, which appear as fold-over like artifacts that disrupt the final image quality. The artifacts are more likely to be seen if the image distortions of the calibration sequence and the actual sequence deviate from each other. For example, in a gradient recalled echo image there may be curled and striped artifacts, whereas in a fast spin echo image bright curved stripes may be seen.

The present invention contemplates an improved method and apparatus that overcomes the aforementioned limitations and others.

It is an object of the present invention to provide an improved method of coils'sensitivity estimation for parallel imaging in order to provide improved image quality with a reduction in the number and magnitude of visible artifacts.

According to one aspect, a method of improved coil sensitivity estimation is provided for reducing artifacts in an MRI apparatus utilizing parallel imaging. The method includes performing a calibration sequence in relation to an imaging sequence and using either a spin echo type sequence for each calibration or a gradient recalled echo sequence with a short echo time for each calibration, and matching the phase encode direction of the calibration scan and the parallel imaging scan.

According to another aspect, an MRI apparatus is provided that includes a magnet system for generating a B₀ magnetic field in an examination zone. The apparatus includes a means for exciting and manipulating magnetic resonance in the examination zone and a means for spatially encoding the magnetic resonance. Also provided is a plurality of coils with differing sensitivity profiles for receiving resonance signals in parallel and a means for reconstructing received resonance signals into image representations. Another means generates sensitivity profiles of the coils from image representations generated during a calibration scan. Still another means generates a diagnostic image from the sensitivity profiles and image representations generated during a diagnostic scan. A sequence control means for accessing a calibration sequence memory means to retrieve either an RF refocused spin echo type sequence or a gradient recalled echo type sequence, and controlling the resonance exciting means and the spatial encoding means in accordance with the retrieved calibration sequence to generate resonance signals for the reconstruction means to reconstruct into the calibration image representations. It accesses a diagnostic imaging sequence memory means to retrieve a diagnostic imaging sequence and controls the resonance exciting means and the spatial encoding means to generate resonance signals for the reconstruction means to reconstruct into the diagnostic image representations.

One advantage resides in a reduction of magnitude, phase and position errors occurring in a calibration scan.

A still further improvement resides in the reduced or removed image fold-over artifacts in parallel imaging.

Another advantage resides in the improved image quality.

Numerous additional advantages and benefits will become apparent to those of ordinary skill in the art upon reading the following detailed description of the preferred embodiments.

The invention may take form in various components and arrangements of components, and in various process operations and arrangements of process operations. The drawings are only for the purpose of illustrating preferred embodiments and are not to be construed as limiting the invention.

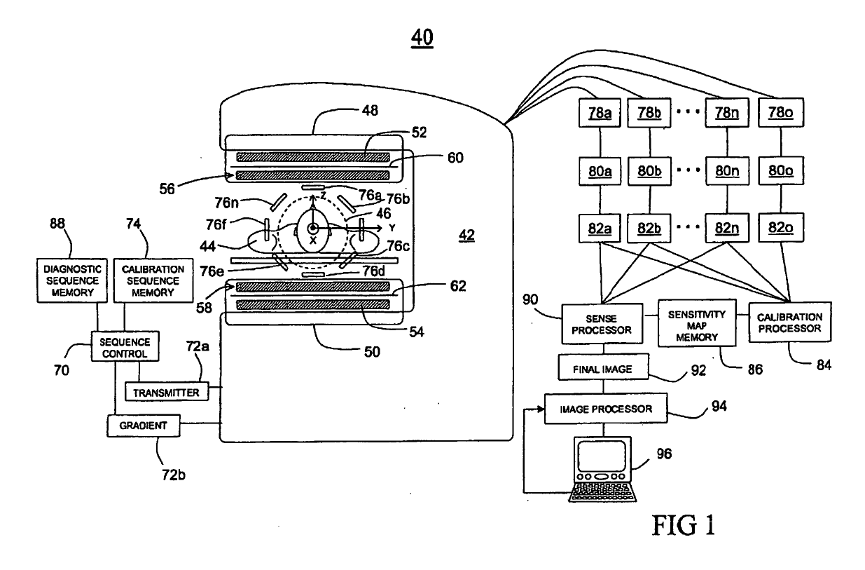

FIG. 1 diagrammatically shows a magnetic resonance imaging system constructed according to the concepts of the present invention;

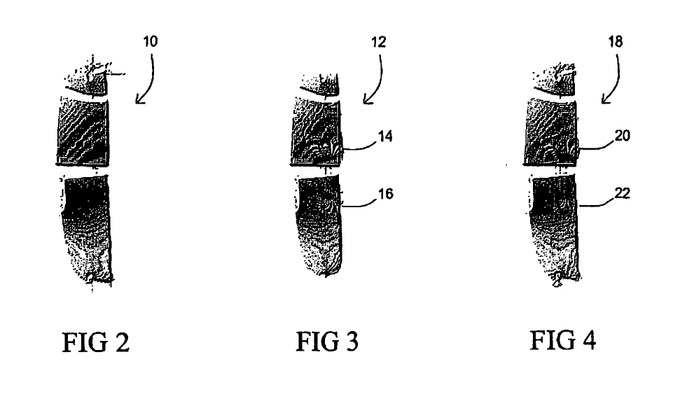

FIG. 2 shows a representation of an MRI image without SENSE acquired using a gradient recalled echo type sequence;

FIG. 3 shows a representation of a SENSE image corresponding to the image of FIG. 2 acquired using a gradient recalled echo based calibration where the phase encode direction of the parallel imaging scan and the calibration scan are orthogonal;

FIG. 4 shows a representation of a SENSE image corresponding to the image of FIG. 2 acquired using a spin echo based calibration where the phase encode direction of the parallel imaging scan and the calibration scan coincide, and the read-out gradients of these two scans are essentially the same in magnitude and direction;

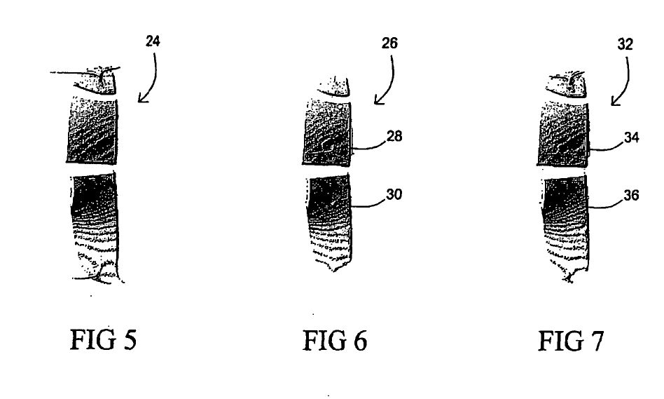

FIG. 5 shows a representation of an MRI image without SENSE acquired using a fast spin echo type sequence;

FIG. 6 shows a representation of a SENSE image corresponding to the image of FIG. 5 acquired using a gradient recalled echo based calibration where the phase encode direction of the parallel imaging scan and the calibration scan are orthogonal; and

FIG. 7 shows a representation of a SENSE image corresponding to the image of FIG. 5 acquired using a spin echo based calibration where the phase encode direction of the parallel imaging scan and the calibration scan coincide, and the read-out gradients of these two scans are essentially the same in magnitude and direction. This results in the same signal bandwidth per unit length in both scans, and the B₀ errors create the same position error measured in mm's. The data sampling time—and thus the resolution in read out direction—of the two scans may differ.

With reference to FIG. 1, a magnetic resonance imaging apparatus 40 includes a main magnet 42 system for generating a temporally constant B₀ magnetic field that extends vertically in an examination zone in the z direction of an xyz coordinate system as shown. A region of interest of a patient 44 is disposed in an examination zone 46 defined by the FOV of the apparatus-often a spherical region. The magnet system includes a ferrous yoke defining a flux return path between pole pieces 48, 50. Coil windings, superconducting or resistive, are disposed adjacent the pole pieces 48, 50 or along the flux return path. Alternately, the yoke can be a permanent magnet.

Gradient coil systems 52, 54 generate spatially variant magnetic field pulses with an approximately linear gradient in the x direction, the y direction or the z direction. A respective resonator 56, 58 that is resonant at the Larmor frequency of a selected dipole, e.g. H₁, is disposed between each gradient coil system 52, 54 and the examination zone. An RF shielding screen 60 is disposed between the resonators and the gradient coils. The resonators 56, 58 and RF shields 60, 62, are arranged in a mirror-image fashion relative to the examination zone. Each resonator 56, 58 preferably functions as a transmit coil, but may also be operative as a receive coil.

A sequence control processor 70 controls a radio frequency transmitter 72a associated with the transmit/receive body coils 56, 58 and a gradient field controller 72b to induce and manipulate spatially encoded resonance as known in the art. More specifically, during generation of a calibration image, the sequence control accesses a calibration sequence memory 74 to retrieve a spin-echo, fast spin echo, or similar sequence in which the phase of the excited resonance is refocused with an RF-pulse. A gradient recalled echo with a very short echo time, e.g. less than 5 msec, is also suitable for calibration.

During the calibration scan, the generated magnetic resonance signals are picked up by a plurality of SENSE coils 76a, 76b, . . . , 76n and demodulated by corresponding receivers 78a, 78b, . . . , 78n. The resonance signals may also be received by the resonators 56, 58 operating in a receive mode and demodulated by a receiver 78o. The resonance data from each of the SENSE coils and the resonators is individually reconstructed 80a, 80b, . . . , 80n, 80o into a plurality of SENSE images stored in SENSE image memory sectors 82a, 82b, . . . , 82n and a reference image stored in reference image memory sector 82o. A calibration processor 84 compares the SENSE images and the reference image to generate sensitivity profiles for the SENSE coils, which are stored in a sensitivity map memory 86.

For final imaging, the sequence control 70 accesses a diagnostic imaging sequence memory 88 to select an imaging sequence. The resonance signals are received by the SENSE coils 76a, . . . , 76n, demodulated by receivers 78a, . . . , 78n, and reconstructed 80a, . . . , 80n into a series of under-sampled, folded images 82a, . . . , 82n. A SENSE processor 90 combines and unfolds the SENSE images in accordance with the sensitivity profile information from the sensitivity map memory 86 to generate a final 3D image for storage in a final image memory 92. An image processor 94 selects and formats portions of the image data for display on a monitor 96.

In the above-described SENSE imaging, the calibration sequence is conducted in order to generate sensitivity profiles or maps of each of the SENSE coils. This calibration scan is typically conducted using field echoes. However, the present inventors have found that when the calibration sequence is used on open scanners, artifacting and errors may occur. Specifically, they have determined that in the open system, the B₀ magnetic field rolls over relatively gradually at the edge of the field of view. The presence of this strong magnetic field variation outside of the field of view causes magnitude, phase and position errors in the calibration scan. Especially it shall be noted that the main field variations create position errors more easily in the read-out direction than in the phase encoding direction.

Coil sensitivity information can be accurately estimated in the regions of the main magnetic field where the above-described distortions appear. This is accomplished by performing the coil sensitivity estimation with a calibration sequence that reduces the phase and magnitude distortions to an equal or smaller level than in the actual parallel imaging scan. The position distortions in the two images shall be about the same.

The inventors have found that by conducting a calibration scan using spin-echo type sequences, this problem can be cured. The refocusing pulse for the spin-echo also refocuses the phase errors, effectively canceling them at the spin echo. Alternatively, a gradient echo based calibration can be used if the echo time is made very small to minimize the accumulated phase errors. Because the errors appear differently in the phase and read directions, the differences between the calibration and SENSE imaging scans are smaller when the phase encode direction(s) in the calibration and SENSE scans are both in the same direction. A still further improvement is provided if the readout gradient direction and magnitude are essentially the same in both the calibration and the SENSE imaging scans.

It is not required that the slice positions of the calibration and diagnostic scan should be exactly the same. It is required that the calibration scan should cover at least the same imaging volume as the diagnostic scan. The coil sensitivity maps for each slice position of the diagnostic scan can be obtained with interpolation.

With reference to FIG. 2, a representation is shown of a first image 10 acquired without SENSE, done with a gradient recalled echo (GRE) type sequence on an open MRI system. With reference now to FIG. 3, a second GRE image 12 of the same subject as used for the first GRE image 10 is shown. However, this image was acquired using SENSE with gradient recalled echo based calibration as known in the previous art. In the second GRE image, curled and striped fold-over artifacts 14, 16, arising from the incomplete unfolding reconstruction due to errors in the sensitivity calibration, are clearly evident when compared to the first image 10.

With reference now to FIG. 4, a third GRE image 18 acquired according to an embodiment of the present invention is shown. In this embodiment, the coil sensitivity estimation is performed with a spin echo type calibration sequence where the phase encode direction of the parallel imaging scan and the calibration scan coincide, and the sampling bandwidth per unit length in the read-out direction of these two scans are the same. Curled and striped artifacts 20, 22 in the third image 18 are clearly reduced when compared to the artifacts 14, 16 of the second image 12. The images of FIGS. 2-4 were all acquired with a repetition time (TR) of 40 ms, an echo time (TE) of 10 ms, a slice thickness of 10 mm, a number of excitations (NEX) of 2, a FOV of 550 mm, a 256×256 matrix, phase encoding in the vertical direction, and a bandwidth (BW) of 62.5 Hz/pixel.

FIGS. 5-7 show a sequence of images acquired in a fashion similar to the images 10, 12, 18 of FIGS. 2-4 but acquired using a fast spin echo (FSE) type sequence. With reference to FIG. 5, a representation is shown of a first FSE image 24 acquired without SENSE. With reference now to FIG. 6, a second FSE image 26 of the same subject as used for the first FSE image 24 is shown. This image was acquired using SENSE with gradient recalled echo based calibration and shows curled and striped artifacts 28, 30 when compared to the first image 24.

With reference now to FIG. 7, a third FSE image 32 was acquired in a manner similar to the second FSE image 26, however, a spin echo based calibration was utilized in place of the gradient recalled echo based calibration. Also the phase encode direction of the parallel imaging scan and the calibration scan coincide, and the sampling bandwidth per unit length in the read-out direction of these two scans are the same. Curled and striped artifacts 34, 36 in the third FSE image are clearly reduced when compared to the artifacts 28, 30 of the second FSE image. The images of FIGS. 5-7 were all acquired with a TR of 410 ms, a TE of 20 ms, a slice thickness of 3.0 mm, a NEX of 3, a FOV of 550 mm, a 288×288 matrix, phase encoding in the vertical direction, and a BW of 71.4 Hz/pixel.

The invention has been described with reference to a preferred embodiment. The invention has also been described with respect to several alternate embodiments. For example, the invention is not limited to open MR scanners but is valid for any type of magnet configuration, including bore type scanners. Neither is the generation of a reference image with the described transmit/receive body coils 56, 58 necessary, since the reference image can be calculated from a combination image using SENSE coils 76a, 76b, . . . , 76n. These and other variations and modifications of the invention will occur to others upon the reading and understanding of this specification. It is intended that all such variations, alterations and modifications, be included insofar as they come within the scope of the appended claims or the equivalents thereof.

1. A method of improved coil sensitivity estimation for reducing artifacts in an MRI apparatus utilizing parallel imaging, the method comprising:
for a parallel imaging sequence, performing a calibration sequence relative to the parallel imaging sequence, using one of:
a spin echo type sequence matching the in-plane phase encode direction of the calibration and the parallel imaging sequences for each calibration; and
a gradient echo type sequence matching the in-plane phase encode direction of the calibration and the parallel imaging sequences for each calibration.

2. The method as set forth in claim 1, wherein the calibration sequence is performed for each parallel imaging sequence.

3. The method as set forth in claim 2, wherein the calibration sequence is performed prior to each said parallel imaging sequence.

4. The method as set forth in claim 1, wherein the gradient echo type calibration sequence is performed with a very short echo time, e.g. less than 5 ms.

5. The method as set forth in claim 1, further including:
using an essentially identical read out gradient in both the calibration sequence and the parallel imaging sequence.

6. The method according to claim 1, wherein a phase encode direction of said calibration sequence is essentially directed in along a phase encode direction of said parallel imaging sequence.

7. An MRI apparatus having a sequence controller programmed to perform the method as set forth in claim 1.

8. An MRI apparatus that includes a magnet system for generating a B₀ magnetic field in an examination zone, the apparatus comprising:
means for exciting and manipulating magnetic resonance in the examination zone;
means for spatially encoding the magnetic resonance;
plurality of coils with differing sensitivity profiles for receiving resonance signals in parallel;
means for reconstructing received resonance signals into image representations;
means for generating sensitivity profiles of the coils from image representations generated during a calibration scan;
means generating a diagnostic image from the sensitivity profiles and image representations generated during a diagnostic scan;
sequence control means for accessing a calibration sequence memory means to retrieve one of an RF refocused spin echo type sequence and a gradient recalled echo type sequence and controlling the resonance exciting means and the spatial encoding means in accordance with the retrieved calibration sequence to generate resonance signals for the reconstruction means to reconstruct into the calibration image representations and for accessing a diagnostic imaging sequence memory means to retrieve a diagnostic imaging sequence and controlling the resonance exciting means and the spatial encoding means to generate resonance signals for the reconstruction means to reconstruct into the diagnostic image representations.
